(19) United States
(12) Patent Application Publication
(10) Pub. No.: US 2024/0266863 A1
(43) Pub. Date: Aug. 8, 2024

(54) Automatic Backup Power Controller for Aquarium Use

(71) Applicant: Todd Haynes, Knoxville, MD (US)

(72) Inventor: Todd Haynes, Knoxville, MD (US)

(21) Appl. No.: 18/634,780

(22) Filed: Apr. 12, 2024

Related U.S. Application Data
(63) Continuation-in-part of application No. 18/103,412, filed on Jan. 30, 2023, now abandoned.

(51) Int. Cl. H02J 9/06; A01K 63/00

(52) U.S. Cl. CPC H02J 9/061; A01K 63/006; H02J 9/068

(57) ABSTRACT

An automatic backup power controller for aquarium use. When the Backup Box taught by the present invention has normal power applied to it, it energizes the 12-48 volt DC coil and closes the Normally Open side of the relay which sends 12-48 volts through the relay and to the connected pump or power head that is connected to the output port on the Backup Box. When normal power is lost the coil will DE-energize thus opening the Normally Open side of the relay in turn causing the Normally Closed side of the relay to close and send 12-48 volts DC battery power through the Normally Closed side of the relay through the fuse and to the Output connection on the Backup Box. The Output connection on the Backup Box is common to both the Normally Open and Normally Closed terminals on the Relay depending on the state it is in.

### TECHNICAL FIELD OF THE INVENTION

The present invention relates to aquariums, and other bodies of water containing aquatic life. More particularly, the invention relates to a backup battery power control system for providing uninterrupted power to aquarium devices and automatic switching between power sources so as to avoid power interruption.

### BACKGROUND OF THE INVENTION

Fish consume oxygen and produce carbon dioxide. Most of the oxygen enters the aquarium (and CO2 leaves the aquarium) by gas exchange at the water surface. The excess carbon dioxide gases off into the room and fresh oxygen enters the water. With good air exchange the aquarium reaches equilibrium with the levels in the air around the tank, and for the most part, does not vary too much. Good air exchange is the result of good flow in the tank and agitation at the surface of the tank. When the power goes out, so does most of this gas exchange. This isn't a huge issue for most aquariums if we're talking about a short period of time, but the sooner the water movement and surface agitation back up and running the better.

An outage that lasts three hours or more could become problematic for an aquarium. This is because most modern aquariums use electricity to run all of the essential parts that keep it stable, like pumps, filters, heaters, and lights mentioned before. Without electricity to keep all of those moving parts functioning, the environment in an aquarium can become unsettled very quickly. Without power, the most common issues to occur in an aquarium include: Oxygen depletion where fish will still consume oxygen in the aquarium, even if that oxygen isn't being replaced with the help of the filter, as the aquatic life in your tank slowly uses up what's left, a dangerous oxygen depletion will start to occur; Water temperature variation where most aquatic species need water temperatures of 72 to 82 degrees Fahrenheit to remain healthy, Changes in water temperature and lack of water movement may stress fish, and live corals which then puts them at risk for disease. Additionally, as temperatures rise in the aquarium, water begins to lose its capacity to hold oxygen; and ammonia starts to buildup, where without a working filtration system, the ammonia in an aquarium could reach levels that are toxic to fish, live corals and other aquatic life forms.

Fortunately, in most cases the power is only out for a few hours, though depending on location and the magnitude of the cause, outages can turn into days, weeks, or even months. Prolonged or repeated outages to circulation and lighting can have a dramatic effect on the fragile ecosystems of most tanks. Heaters, aerators, filtration systems—all need electrical power to operate and keep fish and live corals alive. They need heat when it is cold, cold when it is hot, and oxygen to breathe and take in at all times. Therefore, it is preferred that such outages be avoided completely or minimized to reduce the impact on aquatic ecosystems. A stable ecosystem is a happy ecosystem.

What is needed is an automatic backup power controller for aquarium use that eliminates the need for inverters, transformers, or multiple complicated part systems and replaces the common 120 volt systems with a directly compatible 12-48 volt DC system.

Many DIY universal Battery backup systems known and available in the prior art require an inverter, starter relay, and 120 volts. What is needed is a battery backup system that can run on lower DC voltages when 12-48 volt standard power is unavailable or interrupted while also eliminating the need for an inverter and starter relay.

Other aquarium pump backup systems require a sensor, a second back up pump, an additional canister aquarium filter, and a microswitch. These prior art solutions are overly complicated designs and use many different parts. Therefore, what is needed is a device for providing an aquarium backup system that uses no sensors or switches and does not require secondary or backup pumps and filters but is designed to use the main filters and pumps in a simple circuit design and works in an autonomous fashion.

### SUMMARY OF THE INVENTION

The present invention teaches automatic backup power for aquarium use. The present invention is an all in one unit that will automatically switch over to battery backup power if the loss of normal plug in receptacle power from events such as a power outage. It has been designed for use with today's more energy efficient 12-48 volt DC aquarium pumps which are powered through “power bricks” which take a home's normal 120 volt AC power and transforms it to 12-48 volts DC which powers the DC pump.

Aquarium hobbyists are always searching for an effective way to keep water moving throughout their aquarium in order to keep oxygen supplied to their Fish, Coral, and inverts. In aquariums, keeping the water constantly moving is necessary in keeping the aquarium inhabitants alive. Some aquarium hobbyists go to great lengths and expenses in order to achieve this by purchasing backup generators and in some cases even whole house generators.

The Backup Box as taught and claimed by the present invention is an aquarium hobbyist dream come true as the loss of normal power will cause it to automatically switch over to battery backup power that the hobbyist configures to meet their own demand. The Backup Box as taught and claimed by the present invention with any 12-48 volt AH battery setup, and it is not a propitiatory system, so it works on any 12-48 volt pump or wave maker. With the use of a battery, set of batteries, or even a battery and DC to DC converter.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a schematic of the battery backup box layout of the present invention and the component parts in a 12 volt-48 volt first embodiment.

FIG. 2 is a schematic of the battery backup box layout of the present invention and the component parts in a 24 volt second embodiment.

FIG. 3 is a schematic of the battery backup box layout of the present invention and the component parts in a 36 volt third embodiment.

FIG. 4 is a schematic of the battery backup box layout of the present invention and the component parts in a 48 volt fourth embodiment.

FIG. 5 illustrates the external sides and corresponding controls and displays of the battery backup box taught by the present invention.

FIG. 6 is a schematic of a 12-48 volt single battery backup box layout of the present invention.

FIG. 7 is a schematic of a 12-48 volt multi outputs for the battery backup box layout of the present invention.

FIG. 8 is a schematic of a made to order multi outputs for the battery backup box using DC to DC booster for different DC voltage pumps layout of the present invention.

FIG. 9 is sketch of the backup box relay as taught by the present invention.

FIG. 10 is a schematic illustrating the variable, multiple battery inputs and outputs as taught by the present invention.

FIG. 11 is a schematic illustrating a “daisy chain” arrangement for voltages from 12-48 volts as taught by the present invention.

FIG. 12 is a sketch of the battery box wiring for one exemplary embodiment of the present invention.

FIG. 13 is a sketch of the internal components and wiring of the backup box of one exemplary embodiment of the present invention.

FIG. 14 is a sketch of the battery box wiring for one exemplary embodiment of the present invention.

FIG. 15 illustrates the external sides and corresponding controls and displays of the battery backup box taught by the present invention.

FIG. 16 is a sketch of the battery box wiring for one exemplary embodiment of the present invention.

FIG. 17 is a schematic of an alternative embodiment of the present invention illustrating the circuit.

FIG. 18 is a front perspective view of an alternative, waterproof embodiment of the present invention.

FIG. 19 is a bottom view of an alternative, waterproof embodiment of the present invention.

FIG. 20 is a top view of an alternative, waterproof embodiment of the present invention with the meter cover in a closed position.

FIG. 21 is a top view of an alternative, waterproof embodiment of the present invention with the meter cover in an open position.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized, and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

The device of the present invention is an automatic backup power controller for aquarium use. The present invention is distinguishable from the prior art system, which incorporated uninterrupted power supplies (UPS), invertors, batteries, and related combinations unsuccessfully. The present invention is a 12-48 volt system, unlike the various attempted prior art solutions which are all 12 volt based systems. Because of the present invention's design as a 12-48 volt DC system, it is designed specifically for DC powered aquarium pumps and does not require an inverter, air pump, or transformer like other prior art solutions.

One advantage of the design of the present invention over the prior art is that it uses the same pump that is connected to normal power as well as battery power by incorporating a 12-48 volt DC powered relay. The present invention does not use multiple pumps and no air pumps like other prior art systems and results in a much simpler and direct component and installation compared to those currently offered and known in the prior art.

The present invention also uses an automatic power switch and uses a 6 or 8 point DPDT relay on a 10-30 amp DC circuit in comparison to air pumps or AC circuits known in the prior art.

The battery setup of the present invention is up to the end user. A user can use a simple inexpensive 12-48 volt DC 7 AH setup or they can make their setup more expensive and last 100's of hours with a multiple 100 AH rated setup that is 12-48 volts DC. The choice is theirs. It is a (BYOB) Bring Your Own Battery system. The goal of the present invention is to make having backup power available in the event of a power outage affordable as well as simple and easy.

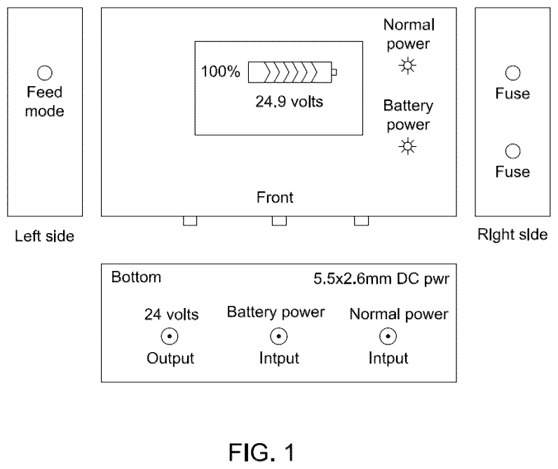

FIG. 1 is a schematic of the battery backup box layout of the present invention and the component parts in a 12 volt-48 volt first embodiment. The battery box of the present invention receives 12-48 volt input from a wall plug via a power brick or transformer converting the 120 volt wall plug to 12-48 volts DC while in normal use. The battery box of the present invention is attached to one or more batteries, where the batteries are 12 volt batteries connected in parallel 12 volt configuration or a maximum 48 volt series configuration depending on the batteries available and storage desired. The battery box of the present invention delivers an output to one or more pumps.

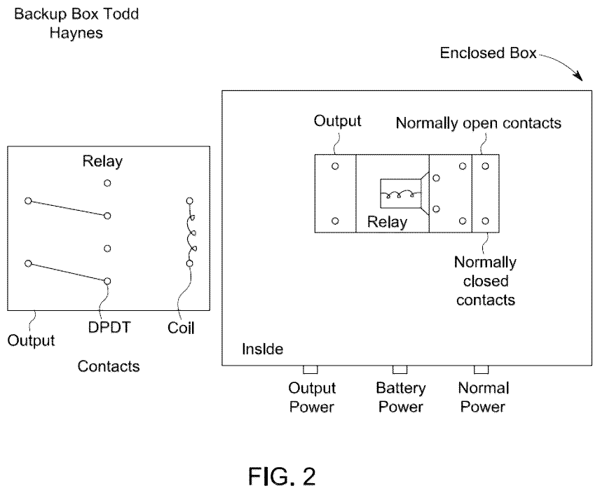

FIG. 2 is a schematic of the battery backup box layout of the present invention and the component parts in a 24 volt second embodiment. The battery box of the present invention receives 12-48 volt input from a wall plug via a power brick or transformer converting the 120 volt wall plug to 12-48 volts DC. The battery box of the present invention is attached to two batteries, where the two batteries are two 12 volt batteries connected in a 24 volt series configuration. Additionally, in this configuration, a 12-48 volt wall charger can be connected to the two batteries are two 12 volt batteries connected in a 24 volt series configuration to provide charging to the batteries while in normal use. The battery box of the present invention delivers an output to one or more pumps.

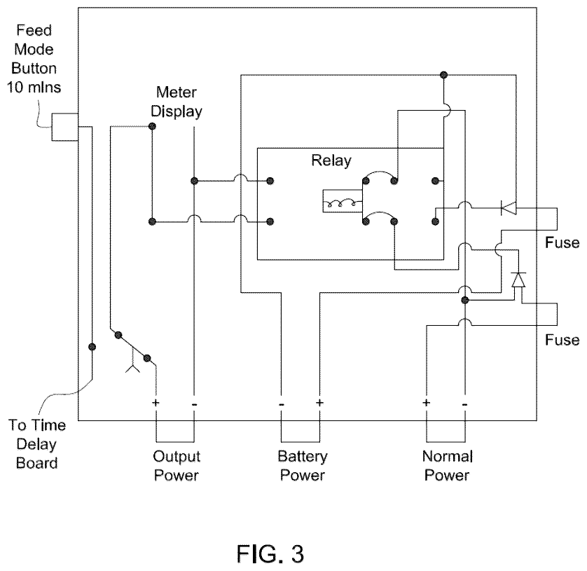

FIG. 3 is a schematic of the battery backup box layout of the present invention and the component parts in a 36 volt third embodiment. The battery box of the present invention receives 12-48 volt input from a wall plug via a power brick or transformer converting the 120 volt wall plug to 12-48 volts DC. The battery box of the present invention is attached to three batteries, where the three batteries are three 12 volt batteries connected in a 36 volt series configuration. The battery box of the present invention delivers an output to one or more pumps.

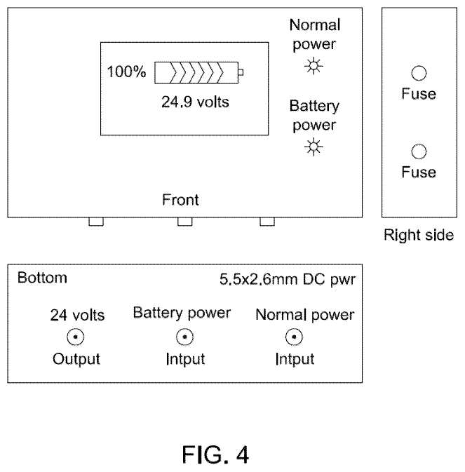

FIG. 4 is a schematic of the battery backup box layout of the present invention and the component parts in a 48 volt fourth embodiment. The battery box of the present invention receives 12-48 volt input from a wall plug via a power brick or transformer converting the 120 volt wall plug to 12-48 volts DC. The battery box of the present invention is attached to four batteries, where the four batteries are four 12 volt batteries connected in a 48 volt series configuration. The battery box of the present invention delivers an output to one or more pumps.

As illustrated by FIGS. 1-4, the present invention can have multiple inputs and outputs depending on the use or application. The present invention can be made and sold in many different configurates to fit a consumer's needs and while specific configurations are illustrated, the present invention should not be limited to those specific, exemplary configurations illustrated.

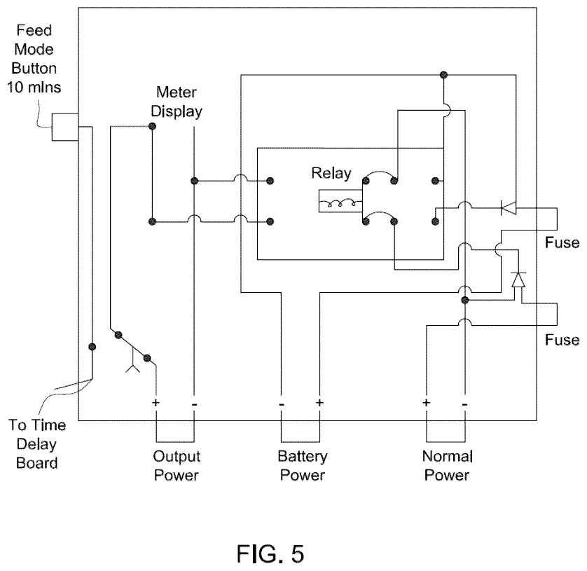

Now referring to FIG. 5, the present invention contains a 12-48 volt battery meter display as well to let the user know how much the battery is charged. It also has an indicator light for both normal and battery power letting the user know that power is available for one or both power supplies.

FIG. 5 illustrates the external sides and corresponding controls and displays of the battery backup box taught by the present invention. The battery box of the present invention teaches two front face displays depending on if the invention is designed for single or multiple outputs. For a single output embodiment, the present invention, on its front surface, has a 12-48 volt display for providing the voltage of the connect battery(s), a green light, and a red light for indicating if that box is charge and prepared to provide backup power. A side face surface of the battery box has the connections for the input, battery connection, and output.

Still referring to FIG. 5, in a multi output configuration embodiment of the present invention, the front face has a green 12-48 volt display and a red 12-48 volt display illustrating the voltage for multiple outputs. Optionally, the front face could contain one or more output connections. The side face surface of the box contains the input and battery connections, as well as the plurality of multiple output connections ranging from 12-48 volts.

The location and orientation of voltage displays, and input, output, and battery connections should not be limited to the preferred embodiments of the present invention as illustrated and exemplified in FIGS. 1-5.

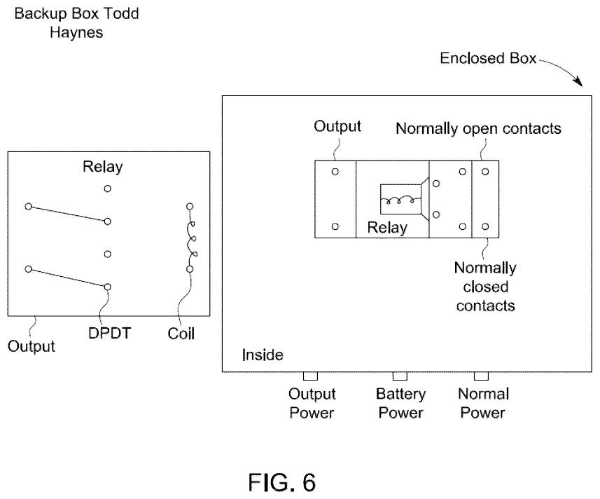

FIG. 6 is a schematic of a 12-48 volt single battery backup box layout of the present invention. In the single box embodiment of the present invention, the 12-48 volt display is connected to and monitors the 12-48 volt output providing a visible display of the actual voltage being provided. A red LED is connected to the 12-48 volt battery bank. A green LED is connected to the normal power input of 12-48 volts from the power bank. Both the battery power and normal power connections to the box are individually and separately fused to provide protection.

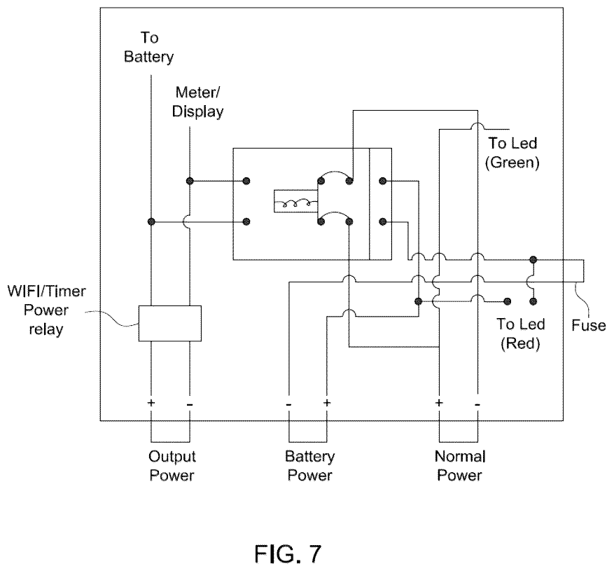

FIG. 7 is a schematic of a 12-48 volt multi battery backup box layout of the present invention. In a 12-48 volt multi box embodiment, a red display is connected to the battery power. A green display is connected to the normal power input. A plurality of outlets are provided. Although the number of outlets show is illustrated as four, any plurality of outlets may be provided for enabled a plurality of devices to be connected. Both the battery power and normal power connections to the box are individually and separately fused to provide protection.

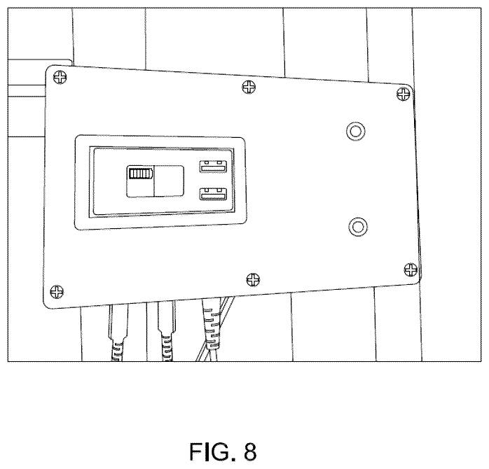

FIG. 8 is a schematic of a made to order multi battery backup box layout of the present invention. In this exemplary custom box, one possible variation of the present invention is illustrated. Here a battery display is connected to the battery to provide a voltage display. An input display is connected to the normal power input 12 volt supply to provide a visual voltage display of the input voltage. Both the battery power and normal power connections to the box are individually and separately fused to provide protection.

Still referring to FIG. 8, a plurality of outputs ranging from 12-48 volts can be provided. Using 12V to 24V boosters a plurality of devices such as 12V can be connected and run prior to the 12V to 24V booster. After the booster a plurality of 24V pumps or devices can be connected.

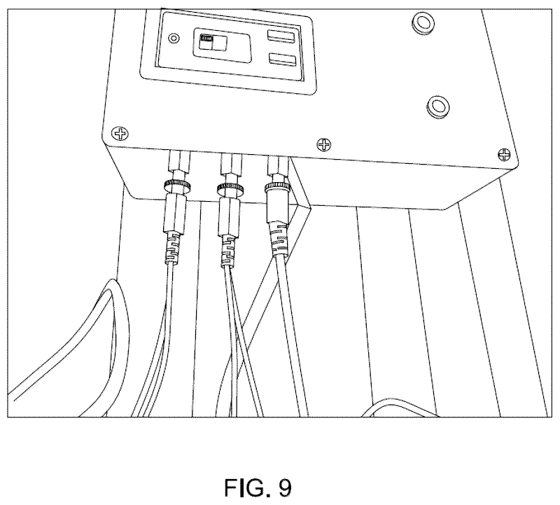

FIG. 9 is sketch of the backup box relay as taught by the present invention. Inside the Backup Box there is a 12-48 volt DC DPDT relay. The normal power connects from the 5.5×2.1 mm connection to the Normally Open contacts on the relay. It also connects to the 12-48 volt coil that pulls the relay in when 12-48 volt DC power is applied. The Battery power from the customers AH battery setup connects on battery connection on the Backup Box which connects to the Normally Closed side of the relay. The output side of the DPDT relay connects to the output port on the Backup Box which connects to the pump or power head.

As shown in FIG. 9, the relay is comprised of one or more output connections, one or more DPDT contacts, and a coil. The relay is located inside an enclosed box housing which retains all the components of the present invention. The relay has both normally open contacts and normally closed contacts.

The normal power connects from the 5.5×2.1 mm jack/connection to the Normally Open contacts on the relay. It also connects to the 12-48 volt coil that pulls the relay in when 12-48 volt DC power is applied. The Battery power from the customers AH battery setup connects on battery connection on the Backup Box which connects to the Normally Closed side of the relay. The output side of the DPDT relay connects to the output port on the Backup Box which connects to the pump or power head.

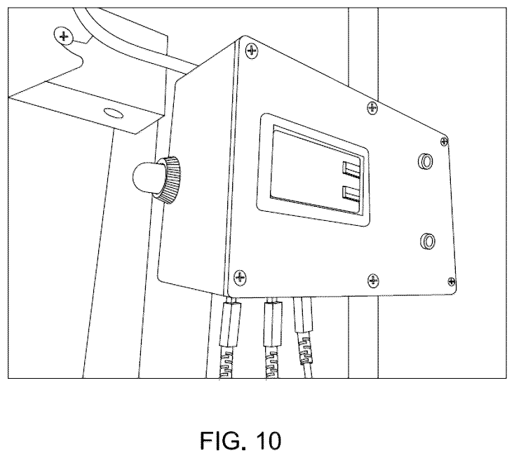

FIG. 10 is a schematic illustrating the variable, multiple inputs as taught by the present invention. The input can be 12-48 volts on input 1, input 2, or both. For example, one input can be 12 volts while the other is 24, 36, or even 48 volts. The present invention teaches different options and is not limited to just two inputs as there could be a single or any plurality of inputs normal power and battery power configured into the box taught by the present invention.

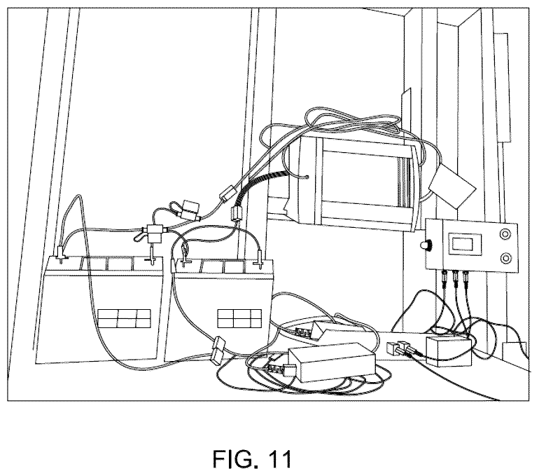

FIG. 11 is a schematic illustrating a “daisy chain” arrangement for voltages from 12-48 volts as taught by the present invention. In this embodiment, two boxes as taught by the present invention are daisy chained for other voltages, i.e., they could be from 12-48 volts. FIG. 11 illustrates the daisy chain connection of a 12 v to 24 v booster box embodiment where the box has an internal 12-48V booster for taking the 12V input and boosting the output to 24V. It could also boost it to 36 v or 48 v.

In the daisy chain configuration the 12V input from one box is connected to the other box, as illustrated the input to the normal 12/24 box is connected to the boosted 12-48V box and the 12V battery connected to the normal 12/24V box is also connected to the battery input of the boosted 12-48V box, which results in the same, singular input being supplied to and shared by the two boxes and the 12V battery being shared between them as well, while one box provides a 24V output and the other 12V outputs. This configures allows the daisy connection of two individual boxes to enable dual output voltages, which can replace or be a substituted from the embodiment of the present invention of FIG. 8 which illustrates a multi-output voltage configuration in a single box, which would be a more expensive produce to produce and have an associated higher sales price.

The embodiment illustrated in FIG. 11 allows a consumer to pick and choose and combine later as needs change or system grows in complexity.

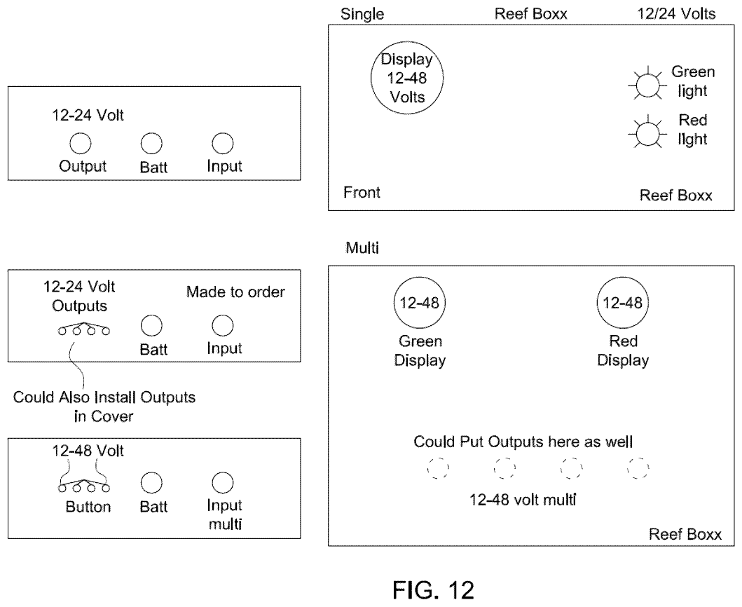

FIG. 12 is a sketch of the battery box wiring for one exemplary embodiment of the present invention. In an alternative embodiment, the present invention can also incorporate a WIFI module/power relay in the box which controls the feed mode and off modes. In this embodiment, the relay output is connected to the battery meter/display as well as the output power jack/connector of the battery backup box, and a WiFi module/power relay and timer are connected between the output power jack/connecter and the relay. In this embodiment, the normal power connects from the 5.5×2.1 mm jack/connection to the Normally Open contacts on the relay.

A green LED light is used to provide a visual monitor of the normal power input status. It also connects to the 12-48 volt coil that pulls the relay in when 12-48 volt DC power is applied. The Battery power from the customers AH battery setup connects on battery connection on the Backup Box which connects to the Normally Closed side of the relay. A red LED light is used to provide a visual monitor of the battery power input status.

The output side of the DPDT relay connects to the output port on the Backup Box which connects to the pump or power head. Finally, fuses a can be added to the normal power input and battery power input lines in combination or individually to provide additional protection to the relay and components as shown in the other figures

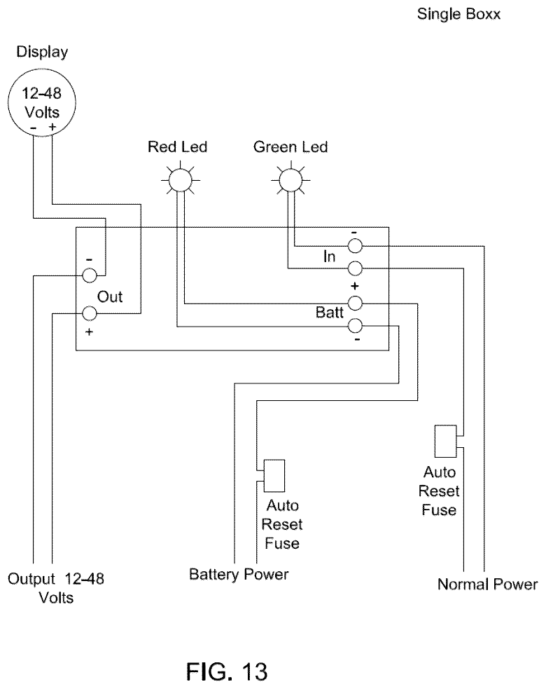

FIG. 13 is a sketch of the internal components and wiring of the backup box of one exemplary embodiment of the present invention. Here it is shown that the relay out is connected to the meter output and output power. The Battery power from the customers AH battery setup connects on battery connection on the Backup Box which connects to the Normally Closed side of the relay. The output side of the DPDT relay connects to the output port on the Backup Box which connects to the pump controller for the pump or power head. Additionally, the feed mode button, typically set for 10 minutes, is connected to a time delay board for providing the feed mode functionality.

In use, when the Backup Box taught by the present invention has normal power applied to it, it energizes the 12-48 volt DC coil and closes the Normally Open side of the relay which sends 12-48 volts through the relay and to the connected pump or power head that is connected to the output port on the Backup Box. When normal power is lost the coil will DE-energize thus opening the Normally Open side of the relay in turn causing the Normally Closed side of the relay to be closed and send 12-48 volts DC battery power through the Normally Closed side of the relay through the fuse and to the Output connection on the Backup Box and out to the pump.

The Output connection on the Backup Box is common to both the Normally Open and Normally Closed terminals on the Relay depending on the state it is in. So, with a loss of power to the 12-48 volt coil the Backup Box will automatically change from normal “plugged in” power to battery power with no effort from the user. So, no matter where they may be if the power goes out the aquarium will continue to run for however long the user has set up their AH battery setup. When normal power is restored, it will energize the coil and automatically switch back to normal “plugged in” power again with no effort from the customer. Then if the customer's AH battery setup is equipped with a trickle charger and the power is restored it will automatically recharge the batteries again with no effort from the user.

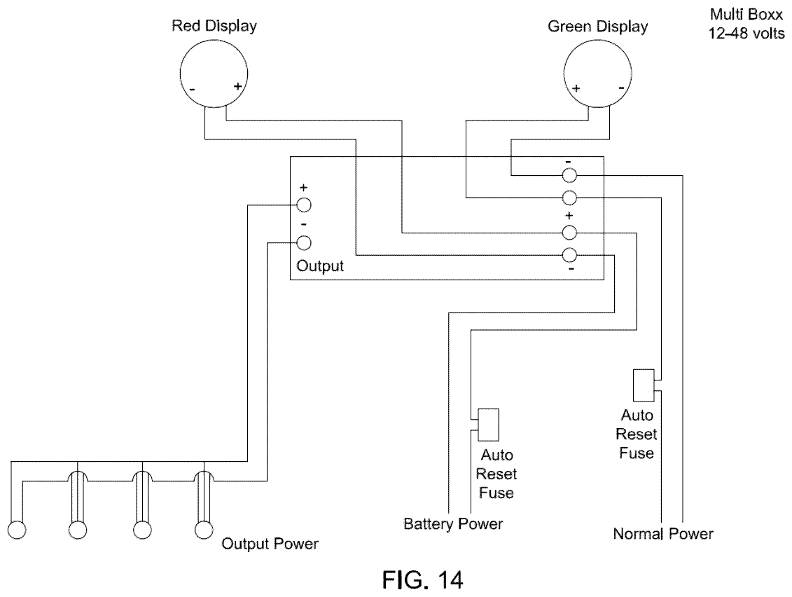

FIG. 14 is a sketch of the battery box wiring for one exemplary embodiment of the present invention. Here the box of the present invention is illustrated. The box can come in multiple sizes and colors to fit consumer needs or tastes. The front/top surface can have one or more 12-48 volt displays and one or more 12-48 volt relay displays. On a side portion, one or more 12-48 volt outputs using batteries or boosters is provided, along with a 12-48 volt battery setup/input connection and a 12-48 volt DC input connection.

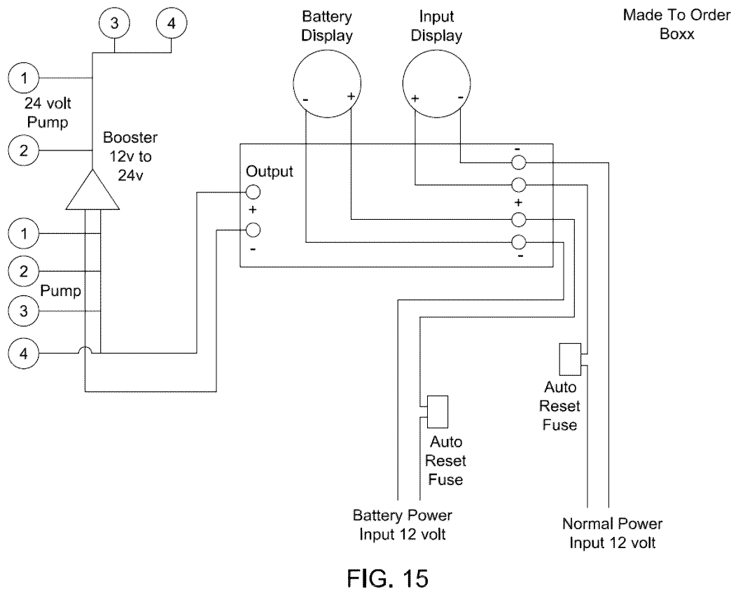

FIG. 15 illustrates the external sides and corresponding controls and displays of the battery backup box taught by the present invention. Now referring to FIGS. 5 and 15, the Backup Box as taught by the present invention is a box that contains 3 5.5×2.1 mm female DC power connectors. One for normal power, one for battery power and one is output power. The normal power is powered by the pumps normal (power brick). The battery power is wired to the customer's choice of an AH battery setup and then connected to the battery connector on the Backup Box. The 3rd and final connector connects a cable from the Backup Box to the pump or power head.

As shown in FIGS. 5 and 15, the Backup Box as taught by the present invention contains a 12-48 volt battery meter display as well to let the user know how much the battery is charged. It also has an indicator light for both normal and battery power letting the user know that power is available for one or both power supplies. As shown in FIG. 15, on the left side when facing the front face with the display, a feed mode button is located for manually placing the box into a feed mode state. On the right side when facing the front face with the display, two fuses are located providing a fused connection to output connections, these fuses may be located internally or externally for easy replacement. As shown in FIGS. 5 and 15, on the bottom side when facing the front face with the display, a 24 volt output, a battery power input, and a normal power input are provided, which are standard 5.5×2.1 mm DC power jacks/connectors.

The battery setup of the present invention is up to the user. A user can use a simple inexpensive 12-48 volt DC 7 AH setup or they can make their setup more expensive and last 100's of hours. The choice is theirs. The goal of the present invention is to make having backup power available in the event of a power outage affordable as well as easy.

With respect to the construction and physical components, all wiring is 14 gage THHN. All parts are rated for 10 Amps. There is a feed mode button on the side of the unit as shown in FIG. 10 to shut down output power for 10 Mins.

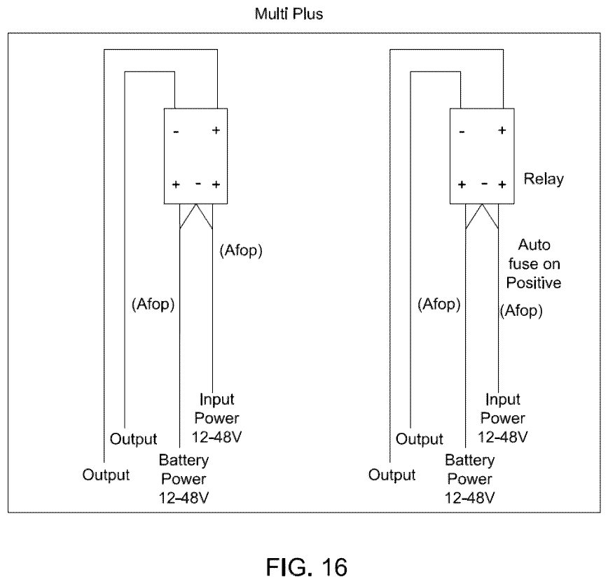

FIG. 16 is a sketch of the battery box wiring for one exemplary embodiment of the present invention. In this embodiment, the box is further comprised of a UPS relay which is powered by a wall outlet and power relay/brick as previously taught connected to the UPS relay ND IN, and additionally having an auto reset 10-30 amp fuse. The UPS relay's NC Batt input is connected to the battery setup. The battery setup can be 12 v, 24 v, 36 v, or 48 v and an auto reset 10-30 amp fuse is provided here as well.

The UPS relay provides multiple displays. In FIG. 16, this exemplary embodiment provides input displays for NC with a red LED or display and ND with a green LED or display, where ND defines the normally open side and NC defines the normally closed side. On the output side of the UPS replay, voltage meter displays are provided for one or more output connects to pumps or other devices via the output jacks.

The UPS relay outputs can provide a plurality of outputs, in any configuration or combination desired. In the exemplary embodiment, all likely outputs in a common configuration desired are shown for illustrative purposes. Here, an un-boosted 12 v output in combination with 24 v, 36 v, and 48 v boosted outputs are shown where the outputs can be connected to one or more pumps ranging from 12-48 volts, using the corresponding/matching voltage booster.

In yet another embodiment of the present invention is simple and compact, yet it still stands in a class of its own. The present invention is a battery backup switch that allows a user to choose which voltage (from 12-36 volts DC) as well as a run time duration. It also allows the user to start with a basic low-cost Amp Hour (AH) battery and then extend their AH run time by adding additional batteries. The present invention is also the first of its kind to utilize the latest and safest Lithium Iron Phosphate (LiFePO4) battery chemistry. It can also be used with all other batteries on the market including lithium ion, lead acid, and will be compatible with the upcoming safe and low-cost Sodium Ion batteries that are just now hitting the market.

This embodiment of the present invention can also be charged with a simple and compact wall mounted charger making charging easy and taking up less space than the original edition and earlier embodiments of the present invention. All outer parts in the newest embodiment are made to be waterproof and the enclosure, which is a multi-part of piece, also contains a gasket making the present invention water resistant in case of aquarium spills. This embodiment of the present invention can be accidentally dropped into an aquarium dried off with a towel and will still be fully functional. The latest embodiment uses connectors with gaskets and rubber covers, a new rounded style output meter with gasket and water-resistant cover to cover the USB connections and high-grade waterproof LEDs with gaskets. Ensuring a water-resistant enclosure.

This embodiment also will display voltage readings ranging from 12-36 volts directly on the latest meter unlike the original style. The new LEDs brightness is dependent on the voltage applied have a dimmer light at 12 volts and a brighter light at 36 volts. This embodiment also uses a more compact relay, and the fused protection has been moved from the outside of the enclosure to inside the actual enclosure using self-resetting fuses. In this embodiment of the present invention the inventor has dropped the “feed mode” and “Wi-Fi” options as they were found them to be unnecessary after testing. The latest edition is rated at 10 amps and is protected with 10-amp self-resetting fuses on both the input port and battery input ports.

The present invention stands in a class of its own as no other device on the market allows the users to:

The present invention enables voltage selection as it is rated for use of 12-36 volts DC.

The present invention can back up more than one pump.

The present invention allows the user to decide which brand and how much battery time they will use to back up their pumps.

The present invention allows the use of many different manufacture's pumps (the present invention is not proprietary) and works with just about all manufacture's pumps.

The present invention allows users to power two different voltage pumps with just one present invention.

The present invention is water resistant to being submerged in an aquarium.

The present invention allows users to build their own AH run time lengths.

The present invention allows the user to pick the battery chemistry that best suits their budget and can be changed as technology evolves.

The present invention allows users 5-volt outputs for power loss outages use of charging phones, use of air pumps, or many other devices.

The present invention provides for continued running of the users pumps through powers loss outages at 100% pump set speeds. (other manufactures drop voltages to save battery life)

Design and operation of the present invention has been made to eliminate issues with workmanship and electric failure. The latest edition of the present invention has a power input port, a battery input port, and two output ports.

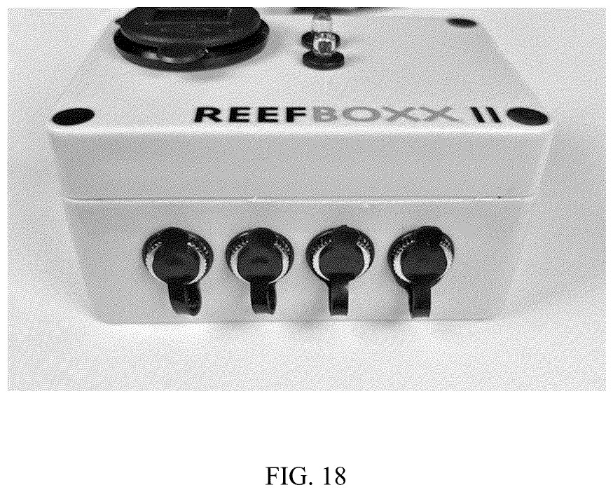

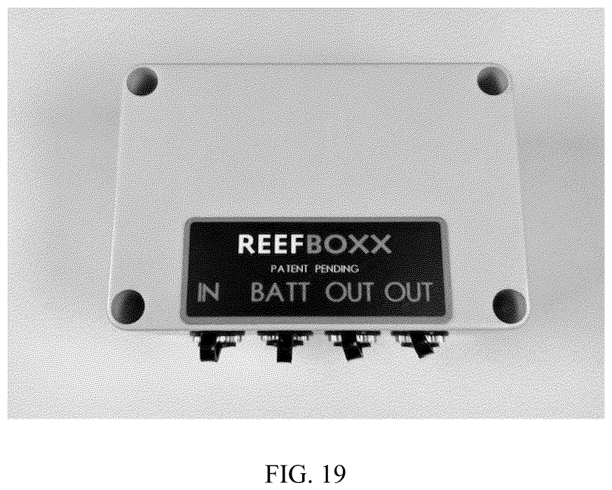

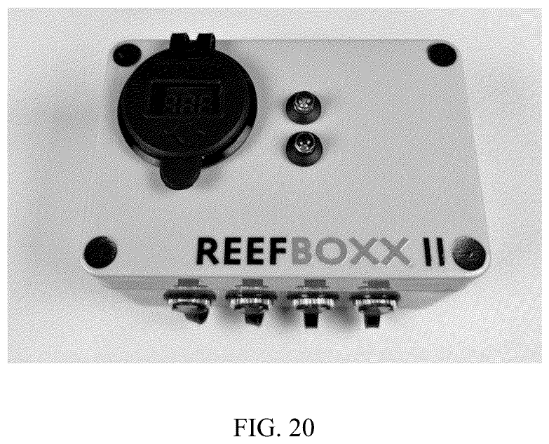

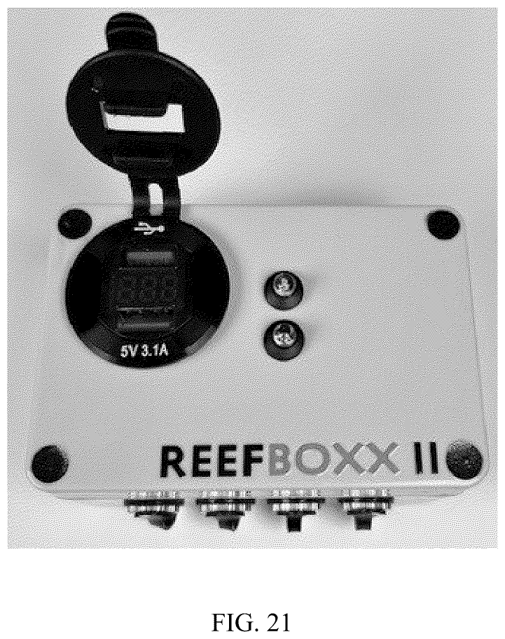

The latest edition of the present invention is enclosed in a high strength plastic and measures at a compact approximate size of 3⅞″×2⅝′×2″ and is available in black and white colors. FIG. 18 is a front perspective view of an alternative, waterproof embodiment of the present invention. FIG. 19 is a bottom view of an alternative, waterproof embodiment of the present invention. FIG. 20 is a top view of an alternative, waterproof embodiment of the present invention with the meter cover in a closed position. FIG. 21 is a top view of an alternative, waterproof embodiment of the present invention with the meter cover in an open position.

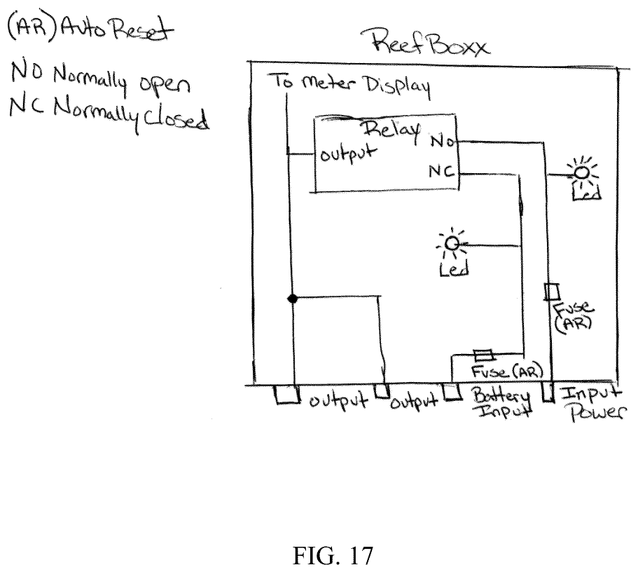

FIG. 17 is a schematic of an alternative embodiment of the present invention illustrating the circuit. The Input port is used to supply wall power to the normally closed terminal to the output terminal on the relay. The battery input port is used to supply battery backup power to the normally open terminal to the relay output terminal. The output ports are wired to the relay output terminal allowing power to flow to the pump or device that is being backed up.

In operation a cable is connected, and 12-36 volts DC is applied to the input port. A cable is connected, and 12-36 volts DC is applied from the battery bank to the battery port.

A cable is connected to one or both output ports and 12-36 volts is applied to the pump(s).

In normal operation 12-36 volts dc is applied to the input port, and flows through the self-resetting fuse, to the green led and to the normally open terminal of the relay. Powering the normally open terminal of the relay causes the normally open terminal to close allowing power to flow through the relay to the output terminal of the relay to the meter display and onto the output port powering the connected pump with normal grid power.

In normal operation, the red and green LEDs are energized showing that normal and battery power are available.

In battery backup operation with the loss of grid power, the applied power to the normally open terminal is dropped allowing the relay to open the normally open terminal in turn closing the normally closed terminal. 12-36 volts dc is applied from the battery to the battery input port and flows through the self-resetting fuse, to the red led, and to the normally closed terminal of the relay, through the relay to the output terminal of the relay to the meter display and onto the output port powering the connected pump with off grid battery power.

In battery backup operation, only the red LED is energized showing that only battery power is available.

In normal power returns operation with grid power returning the normally open terminal is energized causing the relay to instantly close the normally open terminal in turn opening the normally closed terminal allowing the Normal operation to take place again. If a small charger is connected to the battery bank, when power is restored, it will power up and recharge the battery bank so that battery power is again at 100% waiting for another power loss.

Thus, it is appreciated that the optimum dimensional relationships for the parts of the invention, to include variation in size, materials, shape, form, function, and manner of operation, assembly, and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. An automatic backup power controller for aquarium use, comprising:
a box for enclosing an electrical circuit and components;
the electrical components including:
a 12-48 volt DC DPDT relay;
three 5.5×2.1 mm female DC power connectors;
a first female DC power connector for normal power input;
a second female DC power connector for battery power input, and
a third female DC power connector for output power for connecting a cable from the device to a pump or power head.

2. The device of claim 1, wherein
the system is a 12-48 volt system;
the battery box receives 12-48 volt input from a wall plug via a power brick or transformer converting the 120 volt wall plug to 12-48 volts DC;
the battery box is attached to one or more batteries, where the batteries are 12 volt batteries connected in parallel 12 volt configuration or a maximum 48 volt series configuration;
both the battery power and normal power connections to the box are individually and separately fused to provided protection; and
the battery box delivers an output to one or more pumps.

3. The device of claim 1, wherein
the relay is a UPS relay which is powered by a wall outlet and power relay/brick to the UPS relay ND IN, and additionally having an auto reset 10-30 amp fuse;
the UPS relay's NC Batt input is connected to the battery setup;
the battery setup can be 12 v, 24 v, 36 v, or 48 v and an auto reset 10-30 amp fuse is provided;
the UPS relay provides multiple displays;
input displays for NC with a red LED or display and ND with a green LED or display, where ND defines the normally open side and NC defines the normally closed side;
on the output side of the UPS replay, voltage meter displays are provided for one or more output connects to pumps or other devices via the output jacks; and
the UPS relay outputs can provide a plurality of outputs, in any configuration or combination desired of one or more selected from:
an un-boosted 12 v output in combination with 24 v, 36 v, and 48 v boosted outputs where the outputs are connected to one or more pumps ranging from 12-48 volts, using the corresponding/matching voltage booster.

4. The device of claim 1, wherein
the normal power connects from the 5.5×2.1 mm connection to the Normally Open contacts on the relay;
the normal power also connects to the 12-48 volt coil that pulls the relay in when 12-48 volt DC power is applied; and
the battery power from the AH battery setup connects on battery connection on the device which connects to the Normally Closed side of the relay.

5. The device of claim 1, wherein
the relay is comprised of
one or more output connections,
one or more DPDT contacts, and
a coil;
the relay is located inside an enclosed box housing which retains all the components;
the relay has both normally open contacts and normally closed contacts;
the relay out is connected to the meter output and output power;
the battery power from the AH battery setup connects on battery connection on the box which connects to the Normally Closed side of the relay; and
the output side of the DPDT relay connects to the output port on the device which connects to the pump or power head.

6. The device of claim 1, wherein
when the device has normal power applied to it, it energizes the 12-48 volt DC coil and closes the Normally Open side of the relay which sends 12-48 volts through the relay and to the connected pump or power head that is connected to the output port on the device;
when normal power is lost the coil will DE-energize thus opening the Normally Open side of the relay in turn causing the Normally Closed side of the relay to close and send 12-48 volts DC battery power through the Normally Closed side of the relay through the fuse and to the Output connection on the device;
the output connection on the device is common to both the Normally Open and Normally Closed terminals on the Relay depending on the state it is in;
with a loss of power to the 12-48 volt coil the device will automatically change from normal “plugged in” power to the battery power with no effort from the user; and
when normal power is restored, it will energize the coil and automatically switch back to normal power again.

7. The device of claim 1, further comprising
for a single output embodiment, on a front box surface:
a 12-48 volt display for providing the voltage of the connect battery(s),
a green light, and a red light for indicating if that box is charge and prepared to provide backup power; and
a side face surface of the battery box having the connections for the input, battery connection, and output.

8. The device of claim 1, further comprising
for a single output embodiment, on a front box surface:
the 12-48 volt display is connected to and monitors the 12-48 volt output providing a visible display of the actual voltage being provided;
a red LED is connected to the 12-48 volt battery bank; and
a green LED is connected to the normal power input of 12-48 volts form the power bank.

9. The device of claim 1, further comprising
for a multiple output embodiment, on a front box surface:
a green 12-48 volt display; and
a red 12-48 volt display illustrating the voltage for multiple outputs;
a side face surface of the box contains the input and battery connections, as well as the plurality of multiple output connections ranging from 12-48 volts.

10. An automatic battery backup switch for aquarium use that allows voltage from 12-36 volts DC as well as a run time duration selection, comprising:
a box for enclosing an electrical circuit and components;
the electrical components including:
a 12-36 volt relay having a normally open input, a normally closed input, and an output;
a battery power input;
the battery power input connected to the normally closed relay input through a fuse and LED light;
a power input;
the power input connected to the normally open relay input through a fuse and LED light; and
the relay output connected to a meter display and two output ports.

11. The device of claim 10, in combination with Lithium Iron Phosphate (LiFePO4) battery chemistry.

12. The device of claim 10, in combination with a wall mounted charger.

13. The device of claim 10, wherein the box is multi-piece for enclosing the electrical circuit and components is waterproof and contains
a gasket between box pieces;
uses connectors with gaskets and rubber covers,
a rounded style output meter with gasket; and
a water-resistant cover to cover the USB connections; and
waterproof LEDs with gaskets.

14. The device of claim 10, wherein
the display voltage readings ranging from 12-36 volts directly on the meter;
the LEDs brightness is dependent on the voltage applied and have a dimmer light at 12 volts and a brighter light at 36 volts.

15. The device of claim 10, wherein
fused protection is inside the box using self-resetting fuses;
rated at 10 amps; and
protected with 10-amp self-resetting fuses on both the input port and battery input ports.

16. The device of claim 10, providing for continued running of the pumps through powers loss outages at 100% pump set speeds without any drop voltages to save battery life.

17. The device of claim 10, wherein
the output ports are wired to the relay output terminal allowing power to flow to the pump or device that is being backed up.

18. The device of claim 10, wherein in operation
a cable is connected, and 12-36 volts DC is applied to the input port;
a cable is connected, and 12-36 volts DC is applied from the battery bank to the battery port;
a cable is connected to one or both output ports and 12-36 volts is applied the connected device.

19. The device of claim 18, wherein in normal operation 12-36 volts dc is applied to the input port, and flows through the self-resetting fuse, to the green led and to the normally open terminal of the relay; and
powering the normally open terminal of the relay causes the normally open terminal to close allowing power to flow through the relay to the output terminal of the relay to the meter display and onto the output port powering the connected pump with normal grid power; and
the red and green LEDs are energized showing that normal and battery power are available.

20. The device of claim 19, wherein in battery backup operation
with the loss of grid power, the applied power to the normally open terminal is dropped allowing the relay to open the normally open terminal in turn closing the normally closed terminal;
12-36 volts dc is applied from the battery to the battery input port and flows through the self-resetting fuse, to the red led, and to the normally closed terminal of the relay, through the relay to the output terminal of the relay to the meter display and onto the output port powering the connected pump with off grid battery power; and
only the red LED is energized showing that only battery power is available.

21. The device of claim 20, wherein
with grid power returning the normally open terminal is energized causing the relay to instantly close the normally open terminal in turn opening the normally closed terminal allowing the Normal operation to take place again;
if a small charger is connected to the battery bank, when power is restored, it will power up and recharge the battery bank so that battery power is again at 100% waiting for another power loss.
